(19) United States
(12) Patent Application Publication
(10) Pub. No.: US 2003/0234267 A1
(43) Pub. Date: Dec. 25, 2003

(54) Carrier saddle for small children

(76) Inventor: Mitchell A. Spears, Montevallo, AL (US)

Correspondence Address: Wm. Randall May, Allison, May, Alvis,, Fuhrmeister, Kimbrough & Sharp, 1300 Corporate Drive, Birmingham, AL, 35242, US

(21) Appl. No.: 10/174,127

(22) Filed: Jun. 19, 2002

(51) Int. Cl. A61G 1/00

(52) U.S. Cl. 224/159

(57) ABSTRACT

An adjustable, lightweight, saddle-like apparatus for carrying, or riding, a small child on the back of an adult person while the adult person is positioned on his or her hands and knees is disclosed. The device incorporates features which allow the device to be easily secured to the torso of an adult person and which provides a means of stability, support and balance for the child during rides on the adult's back.

### BACKGROUND

This invention relates generally to child carrier devices or child seat devices and more specifically to a saddle-like apparatus for carrying, or riding, a small child on the back of an adult person while the adult person is positioned on his or her hands and knees. Adults, especially dads and granddads, have always enjoyed giving their children or grandchildren “horsey-back” rides to the joy and delight of the children getting the rides and to the pleasure and entertainment of other adults watching the activity. However, it is often difficult for the lucky child getting to ride on the adult's back to stay on the “horsey”, especially when the “horsey” becomes spirited and decides to “buck” or “rear”. During these rides, the child will generally have trouble gripping the “horsey” for security and in maintaining his or her balance. The child will usually try to grab and hold onto the “horsey's” hair or ears or to grip the “horsey's” clothing or waist belt. This can be a painful and/or extremely uncomfortable experience for the “horsey”. Sometimes the adult “horsey” will put a belt around his or her neck or chest to give the child something better to grip or hold onto (other than the adult's hair or ears), especially during those “spirited rides”. While certainly better than nothing at all, the “belt around the neck” and/or the “belt around the chest” method of providing adult “horsey-back” rides for children is, at best, unstable and, depending on the immediate surroundings, can be very unsafe for both the child and the adult. It would be expedient, therefore, to provide a means to substantially eliminate the lack of stability for the child during adult “horsey-back” rides (especially the spirited ones) and to provide a means of support and balance for the child that is not painful or uncomfortable to the adult “horsey”.

The design and construction of the present invention provides the degree of stability and safety necessary to enhance the enjoyment of those “horsey-back” rides for both the child rider and for the adult “horsey”. The present invention will also add to the enjoyment and comfort level of those adults (especially the moms) watching the activity and will most certainly add to the delight of the children anxiously awaiting their turn for a ride.

### SUMMARY OF THE INVENTION

In view of the foregoing, it is a primary object of this invention to provide a portable, light-weight, saddle-like apparatus designed to be attached to the back of an adult for carrying or riding a small child on the back of the adult while the adult is positioned on his or her hands and knees.

It is another object of the present invention is the provision of a carrier saddle for children which allows a child to safely and securely ride on the back of a willing adult “horsey” while the adult is positioned on his or her hands and knees.

Another object of the present invention is to provide maximum support, balance and stability to a young child desiring to ride on the back of an adult while the adult is positioned on his or her hands and knees.

A further object of the present invention is to provide a safe and secure means to bring joy and delight to small children desiring to ride on the backs of willing adults and to provide entertainment and comfort to adults observing the activity.

According to an embodiment of the invention, a portable, light-weight, compact, carrier saddle for children apparatus comprises a saddle pad having adjustable chest and waist straps, adjustable stirrups and a bridle/reins loop strap.

An advantage of the present invention is the provision of a comfortable saddle-like device for riding or carrying small children on the back of a consenting adult.

A further advantage of the present invention resides in the provision of stirrups for the child's feet and a gripping strap for the child's hands thereby providing a means for the child to stabilize, support and balance himself or herself during “horsey-back” rides.

A further advantage of the present invention is the adjustability of the apparatus and the ease of attachment and removal of the device to and from the adult's back.

Another advantage of the present invention is provision of a carrier saddle apparatus for children which gives the riding child something to grip or hold onto and to balance with other than the adult's “horsey's” hair, ears or clothing.

### BRIEF DESCRIPTION OF THE DRAWINGS

The foregoing and other objects, features, and advantages of the present invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a plan view of a preferred embodiment of the invention shown with the straps, stirrups and bridle/reins fully extended.

FIG. 2 is a front view of the embodiment of FIG. 1 shown attached to an adult “horsey” in a standing position.

FIG. 3 is a perspective view of the embodiment of FIG. 1 shown attached to an adult “horsey” in a hands and knees position with a child on the back of the adult.

### DETAILED DESCRIPTION OF THE DRAWINGS

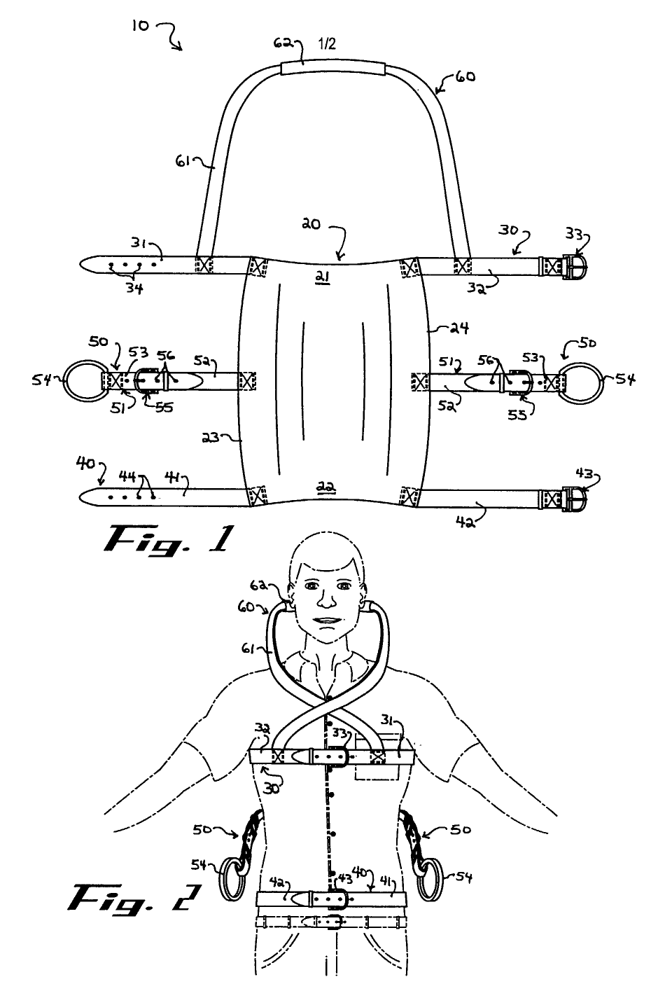

In accordance with an embodiment of the invention, FIG. 1 shows a saddle-like apparatus 10 for attachment to the back of an adult person for carrying or riding a small child on the back of said adult person while said adult person is positioned on his or her hands and knees. Said apparatus 10 comprises a saddle member 20 having a chest securing means 30, a waist securing means 40, a stirrup means 50 and a bridle/reins means 60. Said saddle member 20 comprises an essentially rectangular-shaped section of material, such as leather or heavy fabric, with said member 20 having an upper end 21, a lower end 22, a left edge 23 and a right edge 24.

The chest securing means 30 comprises a pair of left and right straps 31 & 32, respectively, with each strap 31 and 32 being attached at one end to, and extending laterally from, either side of the upper end 21 of the saddle member 20. The right strap 32 is attached at one end to the right edge 24 of said chest securing means 30 and further comprises a typical buckle means 33 attached to its opposing or free end. The left strap 31 is attached at one end to the left edge 23 of said chest securing means 30 and further comprises a plurality of equally spaced holes 34 for connecting with and adjustably receiving the buckle means 33 of said right strap 32. It will be understood that the left and right straps 31 & 32 of said chest securing means 30 may be adjustably connected one to the other by various means, including the use of hook and loop material.

The waist securing means 40 is attached to the lower end 22 of said saddle member 20 and is identical to the chest securing means 30 having left and right straps 41 & 42, respectively, attached at one end to either side of the lower end 22 of said saddle member 20. Said right strap 42 of said waist securing means 40 having a buckle means 43 and said left strap having a plurality of equally spaced holes 44 for connecting with and adjustably receiving the buckle means 43 of said right strap 42. It will be understood that the left and right straps 41 & 42 of said waist securing means 40 may be adjustably connected one to the other by various means, including the use of hook and loop material.

The stirrup means 50 comprises a pair of stirrup members 51 with each stirrup member 51 being attached at one end to, and extending laterally from, either side of said saddle member 20 at a point essentially midway between the upper end 21 and the lower end 22 of said saddle member 20. Each stirrup member 51 comprises a first stirrup strap 52 and a second stirrup strap 53 with said stirrup straps 52 & 53 of each said stirrup member 51 being adjustably connected one to the other. One end of said first strap 52 is attached to the saddle member 20 as previously described and has a buckle means 55 attached to its opposing or free end. The second stirrup strap 53 has a plurality of equally spaced holes 56 along its length for adjustably receiving the buckle means 55 of said first stirrup strap 52. Said second strap member 53 further comprises a stirrup ring 54 attached to its opposing or free end for receiving the foot of a child rider. It will be understood that the stirrup straps 52 & 53 of said stirrup member 51 may be adjustably connected one to the other by various means, including the use of hook and loop material.

The bridle/reins means 60 comprises a length of strap material 61 with one end of said strap material 61 being attached to, and extending perpendicularly from, the right strap 32 of said chest securing means 30 and with the other end of said strap material 61 being attached to, and extending perpendicularly from, the left strap 31 of said chest securing means 30. Said bridle/reins means 60 further comprising a gripping section 62 centrally located along the strap material 61 of said bridle/reins means 60. Said gripping section 62 of said bridle/reins means 60 comprising material having a high friction coefficient, such as rubber or polyurethane tape.

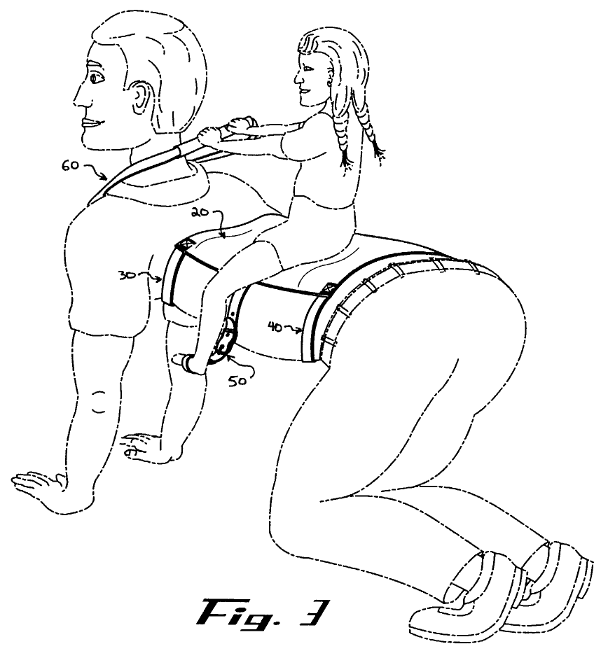

As best seen in FIGS. 2 and 3, the saddle-like apparatus 10 of the present invention is attached to the back of a willing or consenting adult person by placing the saddle member 20 onto adult person's back and then securing the saddle member 20 to the person's body by buckling together the left and right straps 31 & 32 of the chest securing means 30 around the chest of the adult person and by buckling together the left and right straps 41 & 42 of the waist securing means 40 around the waist of the adult person. The bridle/reins means 60 is then cross-looped over the head of said willing or consenting adult person for gripping by the riding child. For maximum support, stability and balance, prior to giving a child a “horsey-back” ride, the length of the stirrup members 51 of the stirrup means 50 should be adjusted to accommodate the length of the child's legs by using the buckle means 55 of said first stirrup strap 52 and the holes of said second stirrup strap 53 in order to lengthen or shorten the connection between said first and second stirrup strap members 52 & 53.

While the invention has been particularly shown and described with reference to the preferred embodiments thereof, it will be understood by those skilled in the art that various alterations in form, detail and construction may be made therein without departing from the spirit and scope of the invention.

The embodiments of the invention in which an exclusive property right or privilege is claimed are defined as follows:

1. An adjustable, lightweight, compact carrier saddle designed to be placed on the back of an adult person for carrying a small child on the back of the adult while the adult is positioned on his or her hands and knees, comprising:
a saddle member;
means for securing said saddle member to the torso of a person, said securing means comprising one or more strap means attached to said saddle member;
a pair of stirrup means attached to either side of said saddle member and extending laterally therefrom; and,
a grip or “reins” member attached at one end of said saddle member.

2. The apparatus of claim 1, wherein said saddle member comprises rectangular-shaped panel of durable and pliable material.

3. The apparatus of claim 2, wherein said material is leather or fabric.

4. The apparatus of claim 1, wherein said strap means of said securing means comprises a set of straps having a first strap member and a second strap member with said first and second strap members being releaseably and adjustably connectable one to the other.

5. The apparatus of claim 4, wherein said first and second strap members are releaseably and adjustably connected one to the other through the use of a buckle mechanism.

6. The apparatus of claim 4, wherein said first and second strap members are releaseably and adjustably connected one to the other through the use of hook and loop material attached to said strap members.

7. The apparatus of claim 1, wherein said means of securing said saddle member to the torso of a person comprises a chest strap and a waist strap.

8. The apparatus of claim 1, wherein said stirrup means are adjustable in length.

9. The apparatus of claim 1, wherein each said stirrup means comprise a first strap member and a second strap member with said first and second strap members being releaseably and adjustably connected one to the other and wherein said first strap member is rigidly attached at one end to said saddle member and wherein said second strap member further comprises a stirrup ring attached to one end thereof.

10. The apparatus of claim 9, wherein said first and second strap members of said stirrup means are releaseably and adjustably connected one to the other through the use of a buckle mechanism.

11. The apparatus of claim 9, wherein said first and second strap members of said stirrup means are releaseably and adjustably connected one to the other through the use of hook and loop material attached to said strap members.

12. The apparatus of claim 1, wherein said grip member comprises an elongated strap member with each end of said strap member being rigidly attached to one of the strap means attached to said saddle member thereby forming a loop.

13. The apparatus of claim 1, wherein said grip member further comprises a gripping section centrally located along said elongated strap member between the ends thereof.

14. The apparatus of claim 13, wherein said gripping section of said grip member comprises material having a high coefficient of friction.
